(19) United States
(12) Patent Application Publication
(10) Pub. No.: US 2005/0212287 A1
(43) Pub. Date: Sep. 29, 2005

(54) Pipe networks

(76) Inventor: Colin G. Caro, London (GB)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/504,517

(22) PCT Filed: Feb. 13, 2003
(86) PCT No.: PCT/GB03/00635

§ 371 Date: Apr. 8, 2005

(30) Foreign Application Priority Data
Feb. 13, 2002 (GB) 0203411.4

(51) Int. Cl. F16L 39/00

(52) U.S. Cl. 285/125.1

(57) ABSTRACT

A pipe network having an area where one planar bifurcation is followed by a second planar bifurcation. The planes of the two bifurcations are not coincident. This reduces non-uniformity in wall shear rates at the exit pipes of the second bifurcation. Preferably, the plane of the second bifurcation is rotated relative to the plane of the first bifurcation. In an alternative form, the pipe network has a planar curve followed by a planar bifurcation, with the planes of the curve and the bifurcation not being coincident.

The present invention relates to pipe networks, and more particularly to pipe networks including bifurcations (i.e. areas where a single entry pipe divides into two separate exit pipes).

Pipe fittings incorporating bifurcations of this type are of course well known, and are normally referred to as T-junctions or Y-junctions depending on the angle of branching. The junctions are normally arranged such that the centrelines of all of the pipes lie in the same plane, and are symmetrical with regard to the centreline of the entry pipe.

It is possible to produce fittings (such as manifolds) in which the entry pipe divides into more than two exit pipes; however, the use of such special fittings can be avoided by using more than one T- or Y-junction fitting. For example, if a flow is to be divided four ways, this could be achieved by attaching a T- or Y-junction fitting to each exit pipe of a first T- or Y-junction fitting. Fluid flow entering the entry pipe of the first T- or Y-junction fitting would be divided in two, and then each of these two flows would be divided in two at the second generation of T- or Y-junction fittings. Of course, if greater division of the flow were needed, then one or more manifolds could be disposed downstream of a bifurcation.

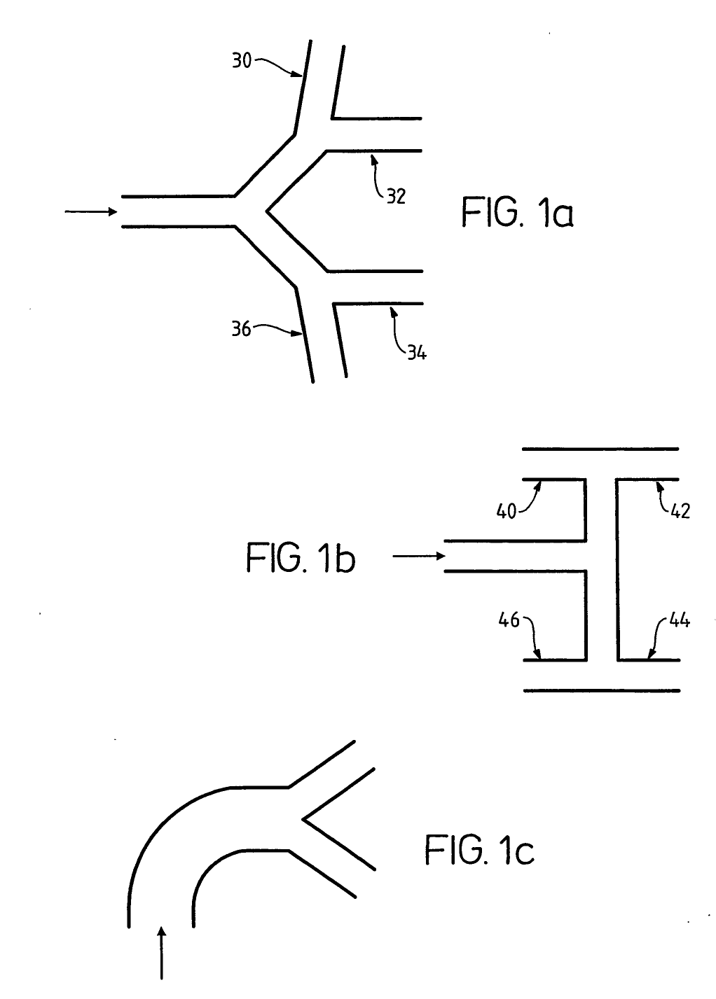

When the second generation of T- or Y-junction fittings are in the same plane as the original T- or Y-junction fitting, so that the overall pipe network has a fan-like appearance (as shown schematically in FIG. 1a), it has been found that the flow in the exit pipes is not symmetric, in that the local relative wall shear rate in the exit pipes in the vicinity of the origin of the exit pipes is not the same, when the initial flow is divided in such a way that the mass flow rate in each of the four exit pipes is the same.

In particular, it has been found that the initial parts of the “inner” exit pipes of the fan (denoted by the reference numerals 32 and 34 in FIG. 1a) have higher relative local wall shear rates than the initial parts of the “outer” exit pipes (denoted by the reference numerals 30 and 36 in FIG. 1a). More accurately, the local relative wall shear rate is higher near the origin of the second-generation daughter tube contiguous with the outer wall of curvature of the first-generation bifurcation than it is near the origin of the second-generation daughter tube contiguous with the inner wall of curvature of the first-generation bifurcation.

A similar result applies to a corresponding network formed from T-junctions, as shown in FIG. 1b, where the local relative wall shear rate is higher in the initial part of daughter pipes 42 and 44 than in the initial part of daughter pipes 40 and 46.

In addition, a non-uniform distribution of the local relative wall shear rate occurs when a bifurcation is downstream of a pipe whose centreline is a planar curve lying in the same plane as the bifurcation, as shown in FIG. 1c.

This non-uniformity of flow conditions in the initial parts of the exit pipes can be undesirable. This is particularly so as lower relative wall shear rates can lead to the formation of stagnation regions, and unduly high wall shear rates can cause erosion or similar damage to the inner surface of the pipe.

According to a first aspect of the invention, there is provided a pipe network having at least one region in which a first-generation planar bifurcation is followed by a second-generation planar bifurcation, wherein the plane of the second-generation bifurcation is not coincident with the plane of the first-generation bifurcation.

It has been found with such an arrangement and equal mass flow rates in the exit pipes of the further bifurcation, that there is reduced non-uniformity in the wall shear rates of the initial parts of the two exit pipes. This arrangement reduces the likelihood of stagnation regions forming in one exit tube and of unduly high wall shear rates in the initial part of the other exit tube.

The plane of the second-generation bifurcation may be rotated with respect to the plane of the first-generation bifurcation, such that the exit pipes of the second T- or Y-junction extend above and below the plane of the first T- or Y-junction, rather than lying in the plane of the first T- or Y-junction. The plane of the second-generation bifurcation may instead be parallel to the plane of the first-generation bifurcation, but offset above or below it. Other arrangements are of course possible.

The network may include two second-generation bifurcations, such that both pipes of the first-generation bifurcation undergo a second bifurcation, wherein the planes of each of the second-generation bifurcations are not coincident with the plane of the first-generation bifurcation.

If the plane of the second-generation bifurcation is rotated relative to the plane of the first-generation bifurcation, then it is preferred for the angle between the planes to be approximately 90°.

This has been found to reduce the non-uniformity of the wall shear rates at the initial parts of the exit pipes. When the angle between the planes of the first-generation and second-generation bifurcations is 90°, the wall shear rates in the initial part of the exit pipes of the second-generation bifurcation appear to be equal, and greater than the lowest wall shear rate encountered with co-planar bifurcations.

The invention also extends to a pipe network having at least one region in which a pipe whose centreline is a planar curve is followed by a planar bifurcation, wherein the plane of the bifurcation is not coincident with the plane of the centreline of the curve.

According to a further aspect, there is provided a method of making a pipe network including such a region.

The invention will now be described in more detail by way of example only and with reference to the accompanying drawings, in which:

FIG. 1a is a schematic plan view of a pipe network including three Y-junction bifurcations, wherein the downstream bifurcations are in the same plane as the upstream bifurcation;

FIG. 1b is a schematic plan view of a similar network using T-junctions;

FIG. 1c is a schematic plan view of a curving pipe followed by a bifurcation;

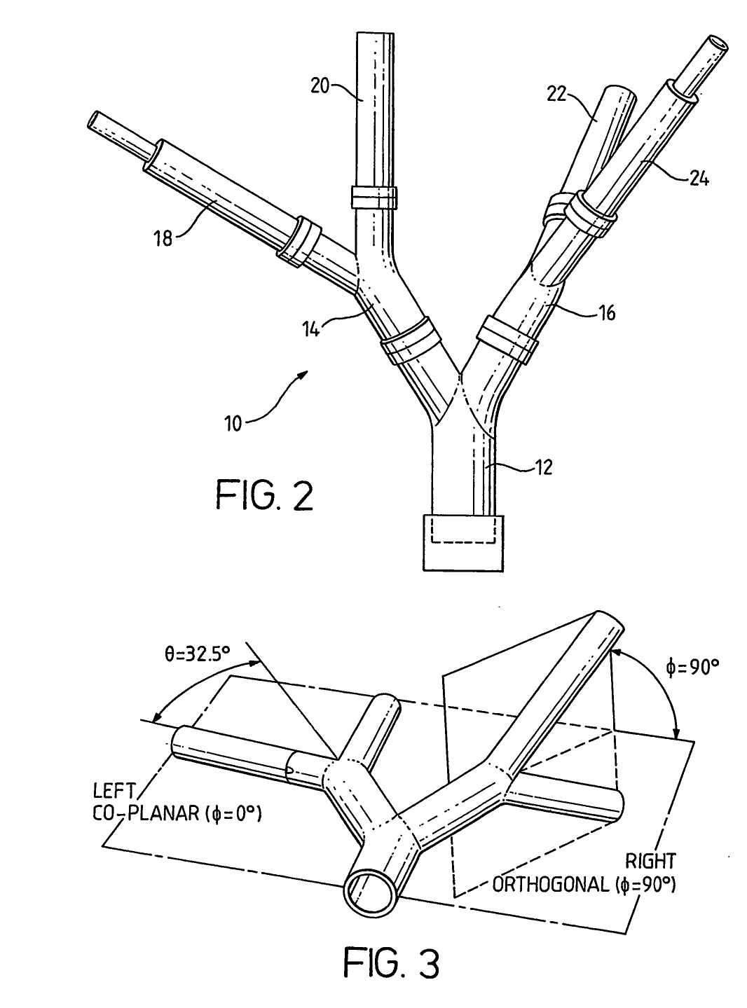

FIG. 2 is a perspective view of an apparatus used to confirm the principle behind the invention; and

FIG. 3 is a schematic drawing showing the layout of the apparatus of FIG. 2.

FIG. 2 shows an experimental apparatus. As can be seen, the apparatus comprises a main Y-junction. Secondary Y-junctions are fitted to the exit pipes of the main Y-junction, and extension tubes are in turn fitted to the exit pipes of each of the secondary Y-junctions.

As best shown in FIG. 3, one of the secondary Y-junctions (the one on the left as shown in FIG. 2) is arranged such that its plane of bifurcation is generally co-planar with the plane of bifurcation of the main Y-junction. The other secondary Y-junction (the one on the right as shown in FIG. 2) is arranged such that its plane of bifurcation is generally orthogonal to the plane of bifurcation of the main Y-junction.

Tubes offering a relatively high resistance to flow were added to the terminations of all the exit tubes, to ensure that the mass flux was the same in all the tubes, irrespective of whether their planes of bifurcation were co-planar with or orthogonal to the plane of bifurcation of the preceding bifurcation.

The Y-junctions and extension tubes were coated internally with a paste of water and starch containing alkaline litmus, which was initially blue. Air flowing into the apparatus carried hydrochloric acid vapour, which caused reddening of the litmus. It can be shown that the rate at which the litmus changes colour is related to the relative local wall shear rate; the faster the colour changes, the higher the relative local wall shear rate. This is a particularly useful method for investigating regional variations in local wall shear rate, as a region having a higher local wall shear rate will become red while a region having a lower local wall shear rate will still be blue.

When acidified air was passed through this apparatus, the initial part of the “inner” exit pipe of the co-planar second generation Y-junction reddened faster than the initial part of the “outer” exit pipe, indicating that the local wall shear rate in the initial part of the “inner” pipe was greater than the local wall shear rate in the initial part of the “outer” pipe.

In contrast, the initial parts of both-exit pipes of the orthogonal second generation Y-junction appeared to redden simultaneously, thus showing that there is no discernible difference between the initial parts of the exit pipes with respect to local wall shear rate. Further, the initial parts of both pipes reddened faster than the initial part of the “outer” pipe of the co-planar secondary Y-junction, indicating that the local wall shear rate in the initial part of each of the orthogonal exit pipes was greater than the local wall shear rate in the initial part of the “outer” co-planar pipe.

There are a number of possible explanations for these phenomena, but it is not intended to discuss these explanations here, as further investigation of the flow is required in order to ascertain which explanation is correct. However, it appears that “skewing” of the flow entering the second bifurcation is an important factor, as this leads to the generation of “swirl flow” in the, exit pipes. Flow of this type is discussed in more detail in GB 2324342. The “swirling” of the flow can be achieved by rotating or offsetting the second-generation bifurcation relative to the first, or by having the fluid flow through a curved pipe whose centreline lies in a plane offset from the plane of the bifurcation.

It will therefore be seen that the use of a bifurcation whose plane is not coincident with that of the first bifurcation decreases the asymmetry of flow in the limbs of the bifurcation. This can increase the minimum local wall shear rate in the initial regions of the limbs, and so reduce the possibility of stagnation regions forming.

The avoidance of stagnation regions can be an extremely important consideration in the design of pipe networks. In particular, when the material flowing in the network is in some way perishable or unstable (for example in the food processing industry), it is very important to ensure that there are no stagnation regions where material could remain and decay. Similarly, in situations where the material flowing in the network is to be changed, as occurs in batch processing, the presence of stagnation regions can lead to cross-contamination between the first and second materials. The use of networks with bifurcations that are not co-planar as described herein can therefore be extremely advantageous in these and other situations.

In addition, the equalization of the local wall shear rate in the exit tubes results in a reduction in the maximum local wall shear rate. As a result of this reduction, the risk of erosion or similar damage to the pipe arising from the flow is reduced.

Further advantages are derived from the reduced asymmetry between the flow conditions in the two exit pipes. For example, if a material flowing is to be heated by means of heat applied to the walls of the pipes, it is difficult to achieve uniform heating in a co-planar bifurcation, because of the differing residence times between the limbs of the bifurcation, and because the variations (and possible local extremes) of wall shear affect the rate of heat transfer. In particular, material being heated will tend to be under-heated in the initial part of the “inner” exit tube, where its residence time will be shorter, and over-heated in the initial part of the “outer” exit tube, where its residence time will be longer. If the flow in the limbs is symmetric, as can be achieved by means of the invention, then the residence times will be the same and thus the heating will be more uniform.

The invention also has application in areas other than industrial piping, and in particular, the reduction in asymmetry can be useful in various biomedical applications. One such application is vascular access grafting, which is often used to access the blood of a patient with kidney failure. A loop is grafted between an artery and a vein of a patient (normally in the forearm), and blood can be led from the loop through a dialysis machine. Such loops normally fail within nine months, as a result of processes induced by local stagnation. However, the stagnation can be reduced by grafting the loop such that the anastomosis formed at the graft site is not in the same plane as the loop upstream of the graft site.

It will be understood that the invention is not restricted to the particular situations discussed, and can be used in any form of pipe network. In addition, the invention has biomedical applications other than the one specifically discussed above.

1. A pipe network having at least one region in which a first-generation planar bifurcation is followed by a second-generation planar bifurcation, wherein the plane of the second-generation bifurcation is not coincident with the plane of the first-generation bifurcation.

2. A pipe network as claimed in claim 1, wherein the plane of the second-generation bifurcation is rotated with respect to the plane of the first-generation bifurcation.

3. A pipe network as claimed in claim 2, wherein the angle between the plane of the second-generation bifurcation and the plane of the first-generation bifurcation is approximately 90°.

4. A pipe network as claimed in claim 1, wherein the plane of the second-generation bifurcation is parallel to but offset from the plane of the first-generation bifurcation.

5. A pipe network as claimed in claim 1, including two second-generation bifurcations, such that both pipes of the first-generation bifurcation undergo a second bifurcation, wherein the planes of each of the second-generation bifircations are not coincident with the plane of the first-generation bifurcation.

6. A pipe network having at least one region in which a pipe whose centerline is a planar curve is followed by a planar bifurcation, wherein the plane of the bifurcation is not coincident with the plane of the centerline of the curve.

7. A method of making a pipe network at least one bifurcation located downstream from a curved pipe or a further bifurcation, said method including the step of arranging the downstream bifurcation such that the plane of the downstream bifurcation is not coincident with the plane of the upstream bifurcation or the plane of the centerline of the curve.

8. A method as claimed in claim 7, for making a pipe network, the network having at least one region in which a first-generation planar bifurcation is followed by a second-generation planar bifurcation, wherein the plane of the second-generation bifurcation is not coincident with the plane of the first-generation bifurcation.
